(19) United States
(12) Patent Application Publication
(10) Pub. No.: US 2010/0264566 A1
(43) Pub. Date: Oct. 21, 2010

(54) RAPID FABRICATION OF A MICROELECTRONIC TEMPORARY SUPPORT FOR INORGANIC SUBSTRATES

(75) Inventors: John MOORE, Camarillo, CA (US); James HERMANOWSKI, Waterbury, VT (US)

Correspondence Address: AKC PATENTS, 215 GROVE ST., NEWTON, MA, 02466, US

(73) Assignee: SUSS MICROTEC INC, Waterbury, VT (US)

(21) Appl. No.: 12/725,351

(22) Filed: Mar. 16, 2010

Related U.S. Application Data
(60) Provisional application No. 61/160,738, filed on Mar. 17, 2009.

(51) Int. Cl. B29C 35/08

(52) U.S. Cl. 264/401; 425/174.4

(57) ABSTRACT

A method for fabricating a rigid temporary support used for supporting inorganic substrates during processing includes providing an inorganic substrate comprising a first surface to be processed and a second surface opposite to the first surface. Next, applying a liquid layer to the second surface of the inorganic substrate and then curing the applied liquid layer and thereby forming a rigid temporary support attached to the second surface of the inorganic substrate. Next, processing the first surface of the inorganic substrate while supporting the inorganic substrate upon the rigid temporary support. The curing includes first exposing the applied liquid layer to ultraviolet (UV) radiation and then performing a post exposure bake (PEB) at a temperature sufficient to complete the curing of the applied liquid layer and to promote outgassing of substances.

### CROSS REFERENCE TO RELATED CO-PENDING APPLICATIONS

This application claims the benefit of U.S. provisional application Ser. No. 61/160,738 filed Mar. 17, 2009 and entitled “RAPID FABRICATION OF A MICROELECTRONIC TEMPORARY SUPPORT TO SUSTAIN SUBSTRATE THINNING AND BACKSIDE PROCESSING”, the contents of which are expressly incorporated herein by reference.

### FIELD OF THE INVENTION

This invention relates to a rapid fabrication method and a liquid polymer system used for rapid processing of a microelectronic temporary support for inorganic substrates, and more particularly to an acrylic polymer system used to encapsulate and planarize the front-side of a device substrate to produce a temporary hard and smooth surface support.

### BACKGROUND OF THE INVENTION

Substrate thinning is a standard practice in the fabrication of microelectronic devices. A thinned substrate is used to enhance cooling of the device during operation, to enable thin substrate stacking, for example, as in three dimensional (3-D) packaging, and to reduce the mass of the final product. Conventional methods to achieve thinning are driven to smaller thicknesses but are limited by the fragile nature of the device substrate, and when pursuing very thin objectives, a support structure is used. Where economic limitations exist, external support structures are not used and the final thickness is governed by the product's brittle properties and the ability to directly handle thin substrates in a tool. Where enabling technology is in demand, device substrates are mounted to external supports (i.e. carriers), whereby a tool handles the support structure and thinning of the microelectronic substrate is achieved without damage.

Examples of final products in microelectronics where there exists a desire to thin substrates includes integrated circuits (IC), microelectromechanical systems (MEMS), and large irregular panel dimensions as in flat panel displays (FPD) and solar substrates. Manufacturing ICs and MEMS are typically conducted upon wafers of standard diameters that are composed of silicon or compound semiconductor species and are taken to ultra-thin values and subsequently stacked to achieve designs in 3-D packaging. Where FPDs and solar panels are concerned, thinned substrates of various shapes are required to reduce weight to meet ergonomic objectives of the final customer package. Conventional technologies for achieving thin device substrates include mechanical grinding and chemical etching, and where ultra-thin dimensions are in demand, various protecting and handling materials are used as tapes, coatings, and externally mounted rigid supports (i.e. carriers).

Consistent with the design pressures of the semiconductor industry, there is a need to reduce the ever increasing heat build-up generated from higher power devices that are continually produced in smaller dimensions and stacked during packaging processes. A common practice is to reduce heat build-up by device thinning and to cool it through thermal conduction (dissipation). To achieve this, an external temporary support (i.e. carrier) is mounted to the wafer to allow ease of handling during thinning and backside processing. The carrier support allows substrate thinning to less than about 100 microns (<100 μm) and is able to sustain many backside processes, including resist pattering, plasma etching, post-etch residue cleans, and metallization.

In IC manufacturing, there is a continued demand to miniaturize devices while a growing desire also exists to stack chips (i.e. 3-D packaging). Achieving these objectives is limited by the ability to reduce substrate dimensions to ultra-thin dimensions. To fully appreciate this need, it is necessary to consider the common and generally accepted phenomena that most, if not all ICs, generate heat as a byproduct of their function and will perform at less than ideal with such heat exposure. In a conventional IC, only a minor proportion of the substrate is used for its performance. Since semiconductors are poor thermal conductors, they will store the generated heat in their mass. As more heat is produced, more is stored, until a metaphysical limit is reached in the electrical circuit at which efficiencies drop and errors occur. To maintain proper IC function, heat must be continually removed as it is generated.

The common method for IC cooling (i.e. heat removal) is to install blowers, which dissipate heat from the printed wire board (PWB). For miniaturized ICs, this means of removing heat is impractical. Hand-held devices such as calculators, cell phones, pagers, and others must depend upon dissipation of heat through conduction. For best results, the IC′ substrate is thinned and brought into direct contact with a heat conducting medium, e.g. heat sink. As the IC′ heat is generated, it is conducted away (dissipated) by intimate contact with a comparatively large heat sink.

Not only does wafer thinning help to dissipate heat, but it also aids in the electrical operation of the IC. Substrate thickness affects impedance and capacitance performance of certain connecting leads, e.g. transmission lines, of given thickness from the top of the IC to the bottom where contact is made to the PWB. Thick substrates cause an increase in capacitance, requiring thicker transmission lines, and in turn, a larger IC footprint. Substrate thinning increases impedance while capacitance decreases, causing a reduction in transmission line thickness, and in turn, a reduction in IC size. In other words, substrate thinning facilitates IC both performance and miniaturization.

An additional incentive in support of substrate thinning involves geometrical reasons. Via-holes are etched into the backside of an IC device wafer to facilitate front side contacts. In order to construct a via-hole (hereafter sometimes referred to as a “Via” or “Vias”) using common dry-etch techniques, minimum geometrical design standards apply. Namely, for IC substrates of the gallium arsenide (GaAs) type with thicknesses of <100 um, a 30-70 um diameter via may be constructed using dry-etch methods that produce minimal post-etch residue within an acceptable time. In silicon substrates of thicknesses of <25 um, vias of much smaller diameter of <10 um, sometimes referred to as through silicon vias (TSVs), are used for communication between stacked chips in 3-D packaging. Due to the complexity of silicon ICs, many TSVs are required for connectivity. As substrates are thinned further to smaller dimensions, smaller diameter vias may be used, requiring shorter etch times, producing smaller amounts of post-etch residue, and promoting greater throughput. Smaller vias require less metallization and in turn, lower cost. Therefore, from the standpoint of backside processing, thin substrates can always be processed quicker and at lower cost.

A final consideration in support of thin substrates is that they are more easily cut and scribed into devices. Thinner substrates have a smaller amount of material to penetrate and cut, and therefore require less effort. Whether the method used is sawing, scribe and break, or laser ablation, microelectronic devices are easier to cut from thinner substrates. In the case where a microelectronic device is manufactured on a wafer, the substrates are thinned after wafer front side operations are complete. In this case, the devices are fabricated onto wafers that exist at their normal full-size thickness, e.g. 600-700 um (0.024-0.028″). Once completed, they are thinned to 100-150 um (0.004-0.006″). In some cases, as in hybrid substrates used for high power devices, e.g. Gallium Arsenide (GaAs), thickness may be taken down to 25 um (0.001″).

Substrate thinning may be performed by mechanical or chemical means. In a mechanical thinning process, the substrate surface to be thinned is brought into contact with a hard and flat rotating horizontal platter that contains a liquid slurry. The slurry may contain abrasive media with chemical etchants such as ammonia, fluoride, or the combinations thereof. The abrasive operates as a “gross” substrate removal means, i.e. thinning, while the etchant chemistry facilitates “polishing” at the submicron level.

Thinning may also be performed by chemical etching. Unlike mechanical processing, substrates enter a tank containing a chemical etchant. Substrates are thinned by the action of a vigorous chemical reaction with the substrate composition. For example, silicon may be etched at rapid rates using a mixture of nitric acid with levels of fluoride present, or by the use of a strong alkali such as potassium hydroxide. Chemical etch rates are typically more difficult to control due to their high rates of removal, which may approach 100 um per minute. Where bath control is needed to achieve greater uniformity, a diluted chemistry with temperature controls is common practice.

In both cases of mechanical and chemical thinning, the substrate is maintained in contact with the media until an amount of material has been removed to achieve a targeted thickness. For a final thickness of 100 um or greater, the substrate is held directly with tooling that utilizes a vacuum chuck or some means of mechanical attachment. While it is of interest to achieve substrate thinning, it is simultaneously an objective to protect the device areas during such processing. Therefore, protection of the device area is maintained by the vacuum chuck, an adhesive film (i.e. tape), or a polymer coating. Once the process is completed, the film or coating must be removed.

Where a substrate thickness is desired to be reduced to <100 um, it becomes difficult or impossible to maintain control, e.g. attachment and handling, by making such contact directly to the substrate. In some cases, mechanical devices may be made to attach and hold onto thinned device substrates, however, they are subject to many problems, especially when processes may vary. For this reason, the substrates may be temporarily mounted onto a separate rigid (carrier) support. These temporary mounted carriers become the holding platform to allow a tool to grab and secure the device substrate during further thinning and post-thinned processing.

Temporary mounted carriers may include sapphire, quartz, certain glasses, and silicon. They and usually exhibit a thickness of 1000 um (1 mm or 0.040″). Substrate choice will depend on how closely matched the coefficient of thermal expansion (CLTE) is between each material. Although it is common to use transparent carriers such as sapphire, quartz, and glass, some cost sensitive processes may use silicon with an alternative practice to the use of visible light microscopy for locating alignment markers or conducting inspection. Where necessary, carrier substrates may be produced with holes, channels (e.g. grooves), or other similar designs. These specially designed carriers offer an enhanced transport of chemical fluids to the surface of the substrate in order to accelerate demount.

All external carriers require the use of an adhesive for mounting onto the device substrate. The adhesive becomes incorporated into the substrate-carrier package (substrate package), whereby its properties must exhibit thermal resistance to be accepted into the steps of thinning and backside processing. The adhesive must maintain a rigid network such that no mechanical compromise occurs (e.g. movement) and any reference points established during mounting will be preserved. The maximum temperature exhibited in wafer backside processing occurs during resist baking, via etching, and deposition of certain metals or oxides. In U.S. Pat. No. 7,098,152 (2006), Moore, a process of using an external temporary carrier is described with an adhesive coating that withstands processing temperatures up to and including 130 degrees centigrade.

Another desire of the adhesive is to exhibit good chemical resistance. This must be established for a range of chemistries from strong etchants used in post-thinning stress relief such as sulfuric, ammonia, and/or peroxide, as well as organic solvents used in the lithography and clean steps during via-hole processing. Ideally, the adhesive must be resistant to these process chemistries, yet be selectively dissolved and removed at the end of the manufacturing process line. At times, certain aggressive chemistries may be chosen which have detrimental effects on the adhesive. As such, some temporary manufacturing measures may be taken to include protective tape or other coverings.

Mounting adhesives used to apply external temporary carriers to silicon and compound semiconductor wafers are disclosed in U.S. Pat. No. 6,869,894 (2005), Moore, and in Mould, D., and Moore, J., A New Alternative for Temporary Wafer Mounting, GaAs ManTech Conf. and Proc., pp. 109-112, (2002). The compositions and practices identified in these references provide the necessary conditions as an adhesive coating that is thermally resistant up to and including 130 degrees centigrade. In U.S. Pat. No. 7,232,770 (2007), Moore et al., and the publication by Moore, J., Smith, A., and Kulkarni, S., High Temperature Resistant Adhesive for Wafer Thinning and Backside Processing, GaAs ManTech Conf. and Proc., pp. 175-182, (2004), describes a similar process of using an external temporary carrier with a high temperature resistant adhesive which may be processed at temperatures exceeding 200 degrees centigrade. At the time of this application, other adhesive compositions have been disclosed in U.S. Patent Application No. 2007/0185310 A1 (2007), Moore et al., where thermal and chemical resistant coatings are taught for adhering external temporary carriers that withstand processing temperatures that exceed 200 degrees centigrade and are resistant to polar solvents commonly used in semiconductor fabrication areas, such as n-methyl pyrollidone (NMP).

The polymer compositions as described in U.S. Pat. Nos. 6,869,894 (2005), Moore, 7,232,770 (2007), Moore et al., and U.S. Patent Application No. 2007/0185310 A1 (2007), Moore et al., involve the following chemistries: a thermoplastic rosin-urethane, a thermoset silicone, and a thermoplastic rubber, respectively. With the exception of U.S. Pat. No. 7,232,770 (2007), Moore et al., both U.S. Pat. No. 6,869,894 (2005), Moore and U.S. Patent Application No. 2007/0185310 A1 (2007), Moore et al., involve the casting of polymers from a chemical mixture and curing by evaporation. All of the above noted disclosures require the use of organic solvents during demounting of the external temporary carrier by dissolving and removing the adhesive polymer.

According to the disclosures in the U.S. Pat. Nos. 6,869,894, 7,232,770, and U.S. Patent Application No. 2007/0185310, they all describe different adhesive chemistries. These items are used for traditional methods of attaching an external carrier support made of glass, sapphire, or silicon. The attachment process requires a special tool to coat the substrate, cure, align the substrate and carrier, and mount by using heat or another similar activation step. When demounting, the process is usually reversed, however, an organic chemical is used to penetrate the adhesive, swell the polymer, and facilitate full dissolution such that complete carrier demount from the substrate is achieved.

External carrier supports add unnecessary cost and additional process steps to the overall wafer thinning and backside processing technology. The added costs reflect the need to procure and manage an inventory of carriers and to procure and qualify detailed processing equipment designed to deliver the adhesive, mount and demount this carrier, as well as to clean the residual adhesive from the substrate. In some cases, the external carriers must be specially designed to include drilled holes (perforations) or channels (grooves) to allow for improved operation during chemical demounting. The costs associated with installing special holes or grooves to the ceramic substrates may exceed the costs of the original substrate.

Mounting and demounting of the external carrier can be a lengthy and a delicate process. During mounting, the device substrate is coated with an adhesive and cured to a level sufficient to secure both surfaces. Attention must be given to the adhesive's ability to planarize the device surface, such that the topography is fully encapsulated and protected during the carrier mounting when excessive pressures may be applied. A special tool is used to bring the surfaces of the adhesive coated device wafer and carrier support into contact with each other. Depending upon the adhesive, the mounting process will utilize heat, light exposure, and pressure to achieve cure and facilitate a securely mounted substrate and carrier. Demount is the reverse process, involving the separation of the external carrier from the device substrate by a means of chemical, mechanical, or processes that involve the combination thereof.

Chemical demounting requires the use of perforated support substrates, specially fabricated to increase the rate of chemical penetration leading to dissolution and removal of the mounting adhesive. In this process, the chemistry of choice is an organic solvent that is heated and allowed to diffuse into the holes (perforations) or channels (grooves), as well as the bond line between the external carrier and device substrate. Organic solvents are generally used to demount the external carrier and remove residual polymer adhesive on the device substrate surface. These chemicals are needed in excessive quantities (e.g. 20-40 gallons) in a cleaning process, whereby the substrates travel from one heated bath to another in an effort to demount the external carrier and remove the adhesive to deminimus levels on the device substrate and result in a clean surface. The entire demount process is lengthy, commonly measured in hours.

Alternatively, thermo mechanical demounting may be achieved with thermoplastic adhesives. As taught in U.S. Pat. No. 6,792,991 B2, Thallner, and U.S. Patent Application No. 2007/0155129 (2007), Thallner, separation may be achieved by heating the mounted external carrier and device substrate to a temperature above the melting point of the thermoplastic adhesive while simultaneously applying a shear force in a manner designed to separate the mounted surfaces. In other words, the device substrate is removed from the external support carrier by heat and a mechanical force of a predetermined amount and in an orientation sufficient to demount the two surfaces. Cleaning with a selected organic solvent typically follows to ensure residual adhesive is cleaned from the substrate.

When mechanical separation is conducted, substrate removal is typically faster than diffusion limited chemical demount processes. However, specially designed tools must be used to remove a thinned device substrate from the external carrier without damage to the topography. These tools drive up the overall costs of the process. Although mechanical removal may proceed faster than chemical, a true comparison should consider total substrate throughput. In this case, a chemical process is typically done by a batch process where two or more cassettes of twenty-five (25) wafers are accommodated in a bath as compared to a mechanical tool that operates as a single wafer handling operation. Further, there is an increased risk in substrate damage when using a mechanical device that moves or pulls the microelectronic substrate against the surface of the external support carrier. Where there may be an interest to consider mechanical equipment, such adoption would be difficult to meet the requirements and cost constraints of handling irregular and large substrates such as microelectronic panels.

Another application for substrate thinning, which also requires the use of external carrier supports, is described in the U.S. Patent Applications 2009/0017248 A1 (2009), Larson et al., 2009/0017323 A1 (2009), Webb et al., and in the International Application WO 2008/008931 A1 (2008), Webb et al. These applications describe the use of a layered body that is formed which comprises the substrate being attached to a rigid support (carrier), described here as an external carrier support. The adhesive described is a bilayer system composed of a photothermal conversion layer and a curable acrylate. A preliminary review of the bilayer system appears to emphasize its chemical complexity, however, it follows with claims of improvements during the demount part of the process. The applications cite the use of a laser irradiation device which allows rapid demount of the external support carrier and is followed by a mechanical peeling practice of the curable acrylate from the thinned substrate. Although these improvements may be recognized for demounting the external carrier, concerns exist about the throughput of this design for high-volume substrate manufacturer and its cost effective application to large panels.

A review of the practices used to support device substrate thinning and backside engineering processes in microelectronic manufacturing presents serious and compelling challenges. On average, where thinning is taken down to a minimum substrate thickness of 100 um, it is observed that conventional practices use normal substrate handling tools with low-cost device surface protection, including temporary coatings and tape film coverings. When substrate thickness must be reduced to <100 um, common engineering practices require the use of an external carrier support to handle the device substrate. The use of such an external carrier requires an extensive processing infrastructure that includes numerous steps, such as coating, curing, mounting, and after processing the device substrate, demount. At the time of this filing, the only current technology available is one, which requires the use of external temporary carriers to be used with silicon or compound semiconductor wafers of specific diameters. Therefore, device substrates, which require further thinning must be justified by cost and volume, manufacture.

Many device substrates do not easily fit the shape or cost profile of silicon wafers. In the case of FPD or solar panel device substrates, e.g. large glass pieces which approach 4 square meters, these substrates are not suitable for external temporary carriers and the costs associated with using a carrier support infrastructure is prohibitive to the needs of these markets.

Based upon the challenges presented here, there is a clear and compelling need to replace the use of external carriers as the support for a device substrate during thinning and backside processing. A further need exists to replace the use of external carriers with a material that may be easily fabricated or applied to a device substrate of variable size.

By eliminating the use of external carriers, the need for detailed tooling during mounting and demounting of the external carriers to the device substrate is also minimized or eliminated. Elimination of the external carriers will eliminate the costs associated with keeping an inventory, carrying-out special cleans practices, and the time for inspection to ensure such external carriers are exhibit sufficient integrity for repeated use. The elimination of external carriers will eliminate the need for demounting practices altogether. The lack of a demount practice will eliminate the need for sophisticated tooling to carry-out mechanical separation of the two surfaces. Elimination of the sophisticated tooling will save costs and will increase throughput.

There is a continuing need for improved “green” processing of device substrates in microelectronic manufacturing. A green process and the associated chemistries are those, which will reduce or eliminate the use and generation of hazardous substances. According to the American Chemical Society's Green Chemistry Institute, there are twelve (12) principles, which help to define a green chemistry. Replacing external carriers presents an opportunity to eliminate the needs of organic solvents to demount the device substrate and external carrier and remove residual adhesives. Where processes require the use of chemicals to conduct cleaning a desire exists to use aqueous-based systems and to rinse with DI water.

While there is a desire to address the elimination of external carriers with the use of a material that can be applied simply and be used on device substrates of various sizes and shapes, there also, is a challenge to design a process that is supported by a tool which will enable rapid processing of parts, and finish with the removal of the applied material with an aqueous material that is commonly found in the industry, without deleterious effects to the substrate. There is a continuing emphasis for the microelectronics industry to be green through improving the safety of operations, reducing the use of chemistry, and reducing the generation of hazardous waste. Taking these challenges together, there is a pressing need to provide a consistent and universal process, which uses a composition that meets the objectives of a temporary rigid carrier, and provides high performance, high throughput, a green process, all at a reduced cost of ownership.

### SUMMARY OF THE INVENTION

The present invention involves a temporary polymeric support substrate fabricated directly onto the wafer surface and used as a support to conduct wafer thinning as well as backside processing to support integration practices in three dimensional (3D) packaging. The polymer system is based upon an ultraviolet curable acrylic resin.

In general, in one aspect, the invention features a method for fabricating a rigid temporary support used for supporting inorganic substrates during processing. The method includes providing an inorganic substrate comprising a first surface to be processed and a second surface opposite to the first surface. Next, applying a liquid layer to the second surface of the inorganic substrate and then curing the applied liquid layer and thereby forming a rigid temporary support attached to the second surface of the inorganic substrate. Next, processing the first surface of the inorganic substrate while supporting the inorganic substrate upon the rigid temporary support. The curing includes first exposing the applied liquid layer to ultraviolet (UV) radiation and then performing a post exposure bake (PEB) at a temperature sufficient to complete the curing of the applied liquid layer and to promote outgassing of substances.

Implementations of this aspect of the invention may include one or more of the following features. The applied liquid layer comprises Component A and Component B. Component A comprises a primary acrylic monomer or a blend of acrylic monomers having a concentration ranging from about 50.0 to 99.5 weight % and Component B comprises one or more rosin compounds having a concentration ranging from about 0.5 to 49.5 weight %. The applied liquid layer further comprises Component C. Component C comprises a photoinitiator used to promote curing of the applied liquid layer and has a concentration ranging from about 0.1 weight % to about 20 weight %. The acrylic monomers comprise a compound represented by formula (1),

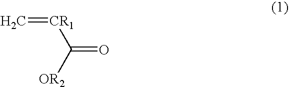

R₁ and R₂ may be one of hydrogen (—H), amide (—NH₂), methyl (—CH₃), hydroxyl (—OH), alcohol (—CH2OH), compounds represented by the formula —CₙH₍₂ₙ₊₁₎ or —CₙH₍₂ₙ₎OH wherein n varies from 2-20, aromatic hydrocarbon functional compounds represented by the formula —C₆X₅, wherein X comprises substituent groups including hydrogen (—H), the halogens (—F, —Br, —Cl, —I), hydroxyl (—OH), and —COOH, and —COOR₃ groups, wherein R₃ may be one of hydrogen (—H), amide (—NH₂), methyl (—CH₃), hydroxyl (—OH), alcohol (—CH₂₀H) and compounds represented by the formula —CₙH₍₂ₙ₊₁₎ or —CₙH₍₂₎OH wherein n varies from 2-20. The one or more rosin compounds may be modified rosins, rosin esters, rosin maleics, rosin-modified phenolics, rosin acids, or hydrocarbon-modified rosin esters. Component B may include one or more of modified rosin esters having a melting point above 150° C. and a total acid number (TAN) equal or higher than 100 mg/g KOH. Component C may include one or more of phenylglyoxylate, benzyldimethylketal, ∝aminoketone, ∝hydroxyketone, monoacyl phosphine (MAPO), bisacylphosphine (BAPO), metallocene, or iodonium salt. The applied liquid layer may further include one or more fillers at a concentration of about 0.1 weight % to about 85 weight %. The fillers act as a special aid during fabrication and provide improved engineering properties during processing. The fillers may be boron nitride, insoluble cellulose, amorphous silica or glass spheres of hollow or solid variety. The method may further include applying a fabric to the second surface prior to the curing. The fabric has an absorptivity value for the liquid layer of above 250 weight % and has fibers from natural organic substances, cellulose, synthetic organic substances, graphite, polyester, nylon, polyamide, polyimide, polyvinylalcohol, inorganic substances, glass or combinations thereof. The curing produces a rigid temporary support having a thermal weight loss of ≦5% as measured by thermal gravimetric analysis (TGA). The liquid layer is applied via a spin-coating or via molding. The method may further include removing the rigid temporary support by washing with an aqueous chemistry.

In general, in another aspect, the invention features a system for fabricating a rigid temporary support used for supporting inorganic substrates during processing. The system includes an inorganic substrate comprising a first surface to be processed and a second surface opposite to the first surface, means for applying a liquid layer to the second surface of the inorganic substrate, means for curing the applied liquid layer and thereby forming a rigid temporary support attached to the second surface of the inorganic substrate and means for processing the first surface of the inorganic substrate while supporting the inorganic substrate upon the rigid temporary support. The means for curing includes means for exposing the applied liquid layer to ultraviolet (UV) radiation and means for performing a post exposure bake (PEB) at a temperature sufficient to complete the curing of the applied liquid layer and to promote outgassing of substances.

Among the advantages of this invention may be one or more of the following. The material is applied to a wafer surface using a variety of means and rapidly cures upon exposure to light of a specific wavelength in the ultraviolet region. Curing proceeds using a high solids mixture, and within seconds upon exposure to ultraviolet light, turns to a solid support carrier structure. There is neither the need for evaporative steps common with conventional adhesives and polymers that are cast from solvents, nor is there a need for external supports composed of ceramics such as glass, silicon, or sapphire which are temporarily adhered to the wafer, and later to be removed.

Once cured, the invention is resistant to many thermal and chemical conditions, which allow wafer thinning, and other processing steps used on the wafer backside. These steps include through silicon via (TSV) etching, vacuum metallization, lithography, cleans, and plating. The manner or sequence by which these steps will depend upon the customer's device platform, available tooling, and general design of their fabrication area (fab). Once finished, selective dissolution of the polymer composition is achieved by using simple aqueous alkaline blends that comprise materials consistent with that of lithography developers (e.g. KOH, NaOH, TMAH, etc.) used in the industry. The removal process may occur by surface spraying, in an immersion bath with agitation, or by other means consistent with standard cleaning practices in wafer cleans.

The invention fulfills a need for a system to rapidly install a temporary rigid wafer structure, acting as a support for thinning and backside processing, and allows easy removal by dissolution into aqueous cleaners, which are common to the industry. The cured structure virtually eliminates process bottlenecks and surface damage, both of which are commonly associated with the use of an external wafer support substrate. This invention simultaneously promotes higher processing throughput, safety, and lower cost, as it neither uses external ceramic supports nor requires organic solvents for cleaning. These properties are needed in wafer processing during plasma etching and other backside processing operations for both compound semiconductor and silicon substrates. These benefits reflect a simplification of the wafer fabrication process and eliminate the use of hazardous organic chemicals.

The International Technology Roadmap for Semiconductors (ITRS, www.itrs.net) is a membership organization that develops initiatives to promote the reduction in chemical usage, energy usage, operator exposure, and the generation of wastes. This invention is considered a “green” product due to its ability to meet these initiatives through process simplification as described earlier and based upon the use of aqueous cleans practices, whereby the polymeric composition is designed to breakdown and dissolves in aqueous alkali.

The invention may be used with a variety of tools that operate from low to high temperature including, through via plasma etchers, metal evaporation systems (i.e., thermal oxide), and high temperature ovens exceeding 200° C. The adhesive is resistant to wide range of aggressive chemicals used in the industry for wafer processing including photoresist strippers, substrate etchants (both acidic and alkaline), and cleaning solvents. Upon completion, thinned and backside processed wafers are produced free of artifacts and residue.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1 depicts the process of support fabrication, thinning and backside processing, and support removal;

FIG. 2 depicts the thickness curve of a spin-coated liquid layer of the temporary support;

FIG. 3 is a schematic diagram of the support fabrication process, using a nonwoven fabric as structural support for the resin system; and

FIG. 4 is a graph of the outgas measurement by TGA methods on unfilled and filled liquid layer materials applied by spin-coating methods.

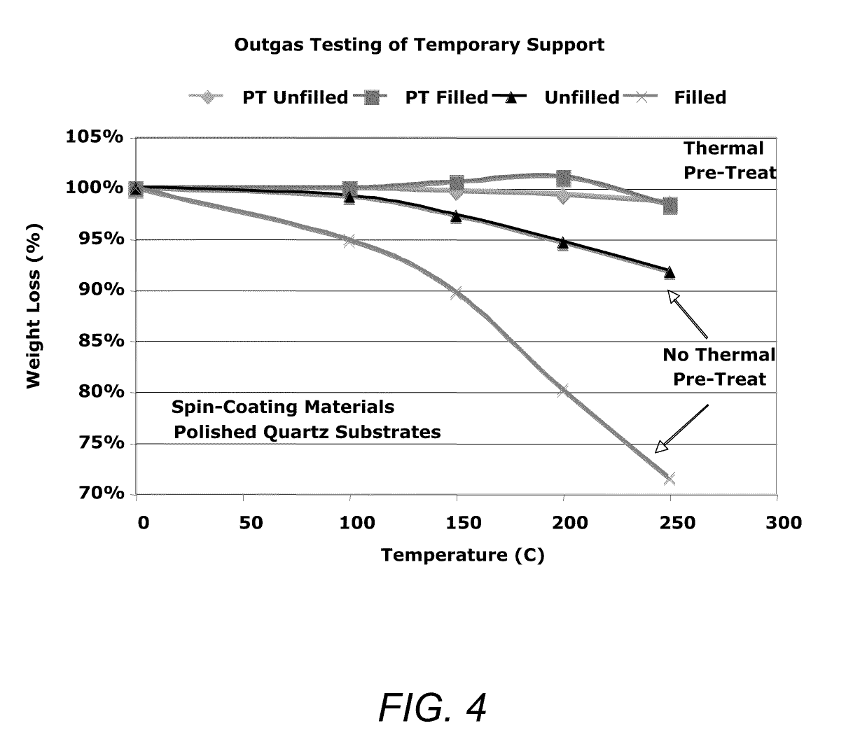

### DETAILED DESCRIPTION OF THE INVENTION

In accordance with this invention, a liquid form polymer system is provided that is applied to wafers by a variety of techniques including spin-on and molding methods. The polymer system is cured onto the wafer and becomes a rigid substrate to support subsequent thinning and backside processing. The polymer system includes an acrylic resin exhibiting acrylamide or hydroxyacrylate character, a terpene rosin of a melting point greater than 150 degrees centigrade and high total acid number (TAN), which upon curing, is resistant to high temperature and chemical deterioration. The cured acrylic system is a support structure that enables wafer processing at temperatures exceeding 200° C. The process of the invention employs a high temperature and chemical resistant polymer mixture based upon cured acrylic resins and common alkaline chemistries used to dissolve and remove the resin once wafer fabrication is complete.

In the process, a mixture of acrylic monomers with high TAN resins is applied to semiconductor wafers and cured by ultraviolet exposure. The cured substrate will support thinning and processing to temperatures exceeding 200° C. and sustain the use of a variety of chemistries for lithography, plating, and cleaning. The application of the resin to the wafer front-side is designed to planarize the surface and encapsulate the device topography. Planarization is required to produce a uniform reference surface for substrate grinding and to allow subsequent mechanical handling. Additionally, the cured polymer acts to protect the wafer front-side surface (i.e., device area) and support the down-force pressures and shear stresses associated with backside thinning as carried out on a grinding and polishing tool.

Following the application of the acrylic thermoset resin, curing is achieved by ultraviolet light exposure of a given energy and for a time sufficient to cure. Photons of a specific wavelength are absorbed by a photoinitiator, which triggers a chemical reaction to form free radicals. These ionized species react with the vinyl group on the acrylic monomer to generate monomer radicals that subsequently react with other monomers to cross-link. This method of curing occurs rapidly to produce a uniform, smooth, chemical and thermal resistant coating.

Depending upon the height extent of wafer topography and the desired thickness of the cured support, the coating method may be from a wide range of practices, to include spin coating, spin-spray, and different molding options. Thickness of the coating may vary from microns to millimeters. The coating effectively penetrates into detailed topography on the wafer surface and rapidly cures upon exposure to produce a completely planarized surface. Once cured, the wafer front-side exists as an encapsulated support structure. The surface is smooth, hard, and exhibits sufficient chemical and thermal resistance to act as a handling structure for the wafer. This substrate supports the wafer to allow thinning, lithography, inserting vias, plating, and dicing. Upon completion of work, the cured polymer may be easily dissolved with aqueous alkalis and rinsed away.

The rapidly fabricated temporary rigid support may be applied to a wide range of topographies on the substrate surface and is not limited by the dimension or shape of the substrate. This temporary rigid support is a major simplification to microelectronic processing by replacing the need for external support carriers and the costly infrastructure, which is needed to support such external support carriers. This invention is a significant improvement as a “green” initiative by eliminating large volumes of hazardous organic solvents normally used to clean adhesive residues that are common with the use of external support carriers, and replacing with aqueous chemistries that are commonly found in the fab.

The liquid form composition includes a blend of polymers combined with additives, which after application, provides a means for penetrating and filling microscopic cavities within the microelectronic topography to achieve a surface that is smooth and of high uniformity. The fabricated temporary support as produced in accordance with the invention exhibits a high level of rigidity and adhesive strength, which taken together, is suitable for a variety of materials. The derived properties are necessary for successful microelectronic substrate exposure to high shear stress during back-grinding and related thinning operations and subsequent backside processing. At process completion, selective chemical penetration by certain alkaline aqueous systems to the cured polymer system causes dissolution and removal from the thinned and processed substrate, leaving the surface in a clean and pristine form. The ability of the liquid composition to meet the desired critical objectives is regarded as representing the unique character of the invention.

The characteristics of the basic material components of the invention include thermal and chemical resistance. Considering the processes that ordinarily apply to most wafer thinning and subsequent backside applications, temperatures observed range from about 110° C. to a high value of >250° C. Namely, the heat of friction during high-shear wafer grinding and thinning can be as high as 110° C., depending upon the substrate, pressure, liquid media, and processing speed. Lithographic baking steps may exhibit similar temperatures. Other application steps, which exhibit heat, include backside via-hole etching and oxide deposition. Etching is commonly conducted by dry etch methods using a chemical plasma in a high vacuum chamber. Recently, the temperatures experienced by plasma etching, for example, in BF₃/BCl₃ (boron tri-fluoride/boron tri-chloride) used to process via-holes through GaAs wafers, have been significantly lowered due to advances in special cooling chucks in contact with the wafer. These temperatures may reach about 130° C., however, these temperatures do not cause significant concern to materials present on the wafer. The high temperatures are typically associated to special deposition or curing steps for chemical vapor deposition (CVD) of oxide or similar, and of coatings or polyimide (PI) or bis-benzocyclobutene (BCB). Coatings resulting from CVD oxide, PI, or BCB, may reach over 300° C. and be held at that level for up to an hour. Few substances are able to comply with these temperatures and retain their performance objectives.

The composition of the invention comprises a mixture of acrylic polymers, a rosin polymer that exhibits an elevated total acid number (TAN), a photoinitiator, and processing aids such as fillers, surfactants, and dyes. This system provides properties, which are capable of planarizing the microelectronic substrate and supporting it in a rigid manner during high shear stress and thermal exposures. Desirable properties include rapid cure, tackiness (adhesion), hardness, clarity, heat stability, compatibility, and solubility.

The invention describes a polymer system that is coated onto the surface of the microelectronic substrate at a substantial thickness sufficient to meet the support and handling requirements for ultra-thin substrates. The applied liquid form of the invention is rapidly converted to a rigid support within seconds using the well-known practice of radiation curing. The art of radiation curing is performed in many markets and described in the following texts: J. Koleske, Radiation curing of Coatings, ASTM international, West Conshohocken, Pa., (2002); C. Hoyle and J Kinstle, Radiation curing of Polymeric Materials, ACS Symposium Series #417, American Chemical Society, Washington, D.C., (1990); R. Davidson, Radiation Curing, Rapra Reports, V. 12, No. 4, Report 136, (2001); and, L. Calbo, Handbook of Coatings Additives, Marcel Dekker, Inc., New York, N.Y., (1987). These references describe acrylic resins, which are instantaneously cured by cross-linking. This invention applies similar technology to the fabrication of a temporary rigid structure on a microelectronic substrate to support thinning, backside processing, and subsequent cleaning of that substrate.

Common radiation curing is conducted by using acrylate monomers, whereby they are initiated with UV light to produce polyacrylates. Acrylics describe a very broad set of polymer chemistry. They represent one of the largest volume products in the polymer industry. Their chemistry is one that involves the use of building block monomers, which when activated, will produce the polymer.

Acrylate monomers contain vinyl groups, the double-bonded carbons directly attached to a carbonyl carbon; these groups are very reactive. Vinyl groups contain shared electrons that are easily stripped away with free-radical species. The species react with the monomer vinyl group's double bond and in-turn, produces a vinyl radical (monomer radical). This monomer radical will then react with another monomer vinyl group's double bond to form a polymer radical. The polymer radical will continue to react with other monomers and propagate a chain of interconnected monomers that increases the molecular weight of the final product. This chain propagation is referred to as free-radical polymerization.

Free-radical polymerization may be initiated by light or heat. Heat may cause spontaneous crosslinking due to the reactive vinyl chemistry. For light stimulated reactions, an initiator must be used. The initiator is chosen according to the wavelength of light that is of interest for the desired process. Initiators are available from many suppliers and are rated based upon reaction efficiency, solubility, thermal resistance, and stability. Benzoin photoinitiators are common for use as initiators for acrylic chemistry. One type of benzoin photosensitizer is 2-phenylacetophenone, which undergoes photoscission to release radicals of benzoyl, and benzyl, which become the primary chain polymerization initiators in the curing process. Photochemically generated free radicals react directly with the double bond of the vinyl monomer as a chain-initiating step.

During polymerization, the moiety and properties of the polymer will depend upon the acrylate monomer. Although acrylates and their corresponding methylacrylates only vary from each other by a methyl group attached to the vinyl carbon, the two systems are very different in their final properties. Acrylates are typically soft and may be opaque while their corresponding methacrylates are clear (transparent) and hard. The methyl group acts to hinder movement in the final form polymer, making it hard and less mobile. These differences are explained by the ability of the respective long chains to move or slip against each other in an acrylate system; however, they are obstructed by the methyl group extension in methacrylates. The inhibition in movement results in an increase in the polymer's hardness.

Although free-radical polymerization suggests a linear product, a high probability exists for combination and disproportionation leading to cross-linking between the chains. This is likely to occur when two or more monomers, which have vinyl character, exist in the mix (i.e. methyl methacrylate, styrene, etc.). In this case, homopolymerization and copolymerization occurs linearly, while cross-linking between the chains exists at hindered locations where bulky side groups are present. Crosslinking enhances condensation to a more dense and less soluble product. Formulating with different monomers can produce a material with unique properties of hardness, thermal and chemical resistance, and adhesion.

In accordance with the present invention, there is provided a mixture of acrylate ester monomers by the general formula described in item (1), where both R₁ and R₂ may represent the following: hydrogen (—H), amide (—NH₂), methyl (—CH₃), hydroxyl (—OH), alcohol (—CH2OH), or any one of the groups represented by the formula —CₙH₍₂ₙ₊₁₎ or —CₙH₍₂ₙ₎OH where n varies from 2-20; aromatic hydrocarbon functional groups of the formula —C₆X₅, where X may be substituent groups such as hydrogen (—H), the halogens (—F, —Br, —Cl, —I), hydroxyl (—OH), —COOH; and —COOR₃ groups, wherein R₃ represents the following: hydrogen (—H), amide (—NH₂), methyl (—CH₃), hydroxyl (—OH), alcohol (—CH2OH), or any one of the groups represented by the formula —CₙH₍₂ₙ₊₁₎ or —CₙH₍₂ₙ₎OH where n varies from 2-20.

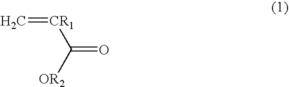

It is to be understood that where substituent groups are present, they should be present in a manner such that they do not unduly hinder or interfere with the photocure of the acrylic monomer.

The preferred acrylic monomers are those represented by item (1), wherein R₁ is a hydrogen (—H), or methyl (—CH₃), defining the molecule as an acrylate or methacrylate, respectively, and R₂ to represent a substituent of the form or —CₙH₍₂ₙ₎OH where n varies from 2-20. Such preferred acrylics include hydroxyethyl acrylate (CAS #818-61-1), hydroxypropyl acrylate (CAS #25584-83-2), hydroxyethyl methacrylate (CAS #868-77-9), and hydroxy propyl methacrylate (CAS #27813-02-1).

The more preferred acrylic monomers are those represented by item (1), wherein R₁ is a hydrogen (—H), or methyl (—CH₃), and R₂ to represent a substituent of the form amide (—NH₂), defining the molecule as an acrylamide. Such preferred acrylics include n,n-dimethylacrylamide (DMAA, CAS #2680-03-7). DMAA has been shown to exhibit a significantly faster curing time over the conventional acrylates or methacrylates.

Although the coating compositions may contain one or more of said acrylic monomers, preferred coating compositions contain a mixture of two monomers, preferably an acrylate, methacrylate, and an acrylamide. When the preferred liquid composition contains a mixture of acrylate or methacrylate with the acrylamide monomers, it is preferred that the ratio, by weight, of the acrylate to the acrylamide to be from about 50:50 to about 80:20 by weight, for acrylate:acrylamide, respectively. Exemplary mixtures of acrylates and acrylamides include mixtures of hydroxyethyl acrylate, hydroxypropyl acrylate, hydroxyethyl methacrylate, and hydroxy propyl methacrylate, with n,n-dimethylacrylamide.

Of particular interest to this invention are the internal properties of the cured temporary rigid support structure and its ability to handle thin and fragile substrates. It is known that cross-linking reactions by radiation curing have the potential to exhibit dramatic condensation as the monomers contract and bond to each other. Many times, this presents a final structure that has shrunk in shape (i.e. reduced size). The shrinking process will also invariably produce a structure under stress. Producing a structure which exhibits no stress is a key objective as the internal stress will be transferred to the thinned microelectronic substrate and raise the risk of bowing, cracking, or worse, complete shattering of the substrate.

It is known that a property in polymers known as the glass transition (i.e. Tg) represents the temperature at which the exhibited properties of that material change from a crystalline to an amorphous nature. Operating above the Tg, those materials would be expected to be classified as amorphous and provide greater flexibility, movement, and potentially lower stress. Therefore, materials with Tg values in the low range are expected to exhibit reduced stress. When comparing acrylates with methacrylates, the Tg values are observed to be lower in the former vs. the latter. Preferred acrylic systems in this invention have enriched acrylates over that of the methacrylates. More specifically, preferred systems are composed of higher concentrations of hydroxyethyl acrylate, (Tg=−7° C.) and hydroxypropyl acrylate (Tg=−15° C.), vs. hydroxyethyl methacrylate (Tg=+55° C.), hydroxy propyl methacrylate (Tg=+73° C.), or even the acrylamide, n,n-dimethylacrylamide (Tg=+119° C.).

Though not essential to the invention, the coating composition generally contains from about 65% to about 95% by weight of the acrylic monomer mixture. The remainder of the composition includes additives to achieve performance properties of the final product. These percentages described here for the acrylics may be reduced by the incorporation of various optional constituents disclosed below.

The invention involves a cure process between a photoinitiator that is present in the liquid polymer system and actinic radiation from an ultraviolet emission source. Common photoinitiators include benzoin ethers, acetophenones, benzoyl oximes, and acylphosphines. These initiators may include phenylglyoxylate, benzyldimethylketal, ∝caminoketone, ∝chydroxyketone, monoacyl phosphine (MAPO), bisacylphosphine (BAPO), metallocene, and iodonium salt. Preferred initiators include 2-hydroxy-2-methyl-1-phenyl-1-propanone (CAS #7473-98-5) and phosphine oxide phenylbis(2,4,6-trimethylbenzoyl)-(CAS #162881-26-7). A trade name product, which represents these materials, includes Irgacure 2022, as manufactured by CIBA Specialty Chemicals, Basel, Switzerland. The product exhibits absorption maxima at 365 nm, 285 nm, and 240 nm. Concentrations are used anywhere at ≦5% by weight.

The invention liquid system also contains a terpene rosin, added as a tackifier and an aid in clean-up due to the high TAN. Rosins are a complex mixture of organic materials having terpene (i.e. pine tree) origin and are industrially sourced from crude gum, wood, and tall oil. The root chemical skeleton from these plant streams includes abietane, e.g. abietic acid, and pimarane, e.g. pimaric acid. These acid moieties of terpene have high total acid number (TAN) values ranging from about 150 to over 300 mg KOH/g, as measured by alcoholic acid titration. However, because these resins are commonly in liquid form at ambient, they must be chemically converted to the desired application state by polymerization pathways, e.g. Diels Alder Addition reactions. As the resins are polymerized, they reach high molecular weights, lose some of their TAN, and begin exhibiting the needed properties, e.g. hardness, adhesion, etc.

Commercially available polymerized terpenes include simple polyterpenes, styrenated terpenes, terpene phenols, and esters. The esters include simple rosin esters, dimerized rosin esters, and hydrogenated rosin esters. More specifically, these modified rosin esters include phenolic and maleic varieties.

The preferred rosin is a gum rosin-modified maleic resin characterized by a melting point above 150° C. and a TAN in excess of 100 mg KOH/g. The rosin is hydrophilic (i.e. polar), offering high solubility in polar organic systems, and pertinent to this invention, will exhibit sufficient solubility in the acrylic monomer system to produce a homogenous mixture. Its concentration in the acrylic system may occur as high as 30%, and is preferred between 5-20% by weight.

Polymerized rosins exhibit thermoplastic character by melting or flowing at high temperature. However, at low temperatures they are extremely hard and crystalline. Although rigidity may help in processing wafers, the more crystalline a material is, the less strength, e.g. ability to withstand force and shock, that it will exhibit. Namely, many rosins will be very hard to the touch, however, when shaken or abruptly moved, the material will crack in a catastrophic manner to cause complete failure. Rosin coatings or pellets are observed to be very hard and impenetrable. When the surface is impacted or vibrated, cracks appear in the structure and will travel throughout until the entire material is reduced to pieces or dust. The hardness of the rosin provides a benefit to the rigid requirements of the invention, while the acrylic system offers a cross-linked support structure that will temper or relax the crystallinity of a rosin. The acrylic network increases the system's strength and alleviates problems of extreme hardness and risk of shattering upon vibration.

An emulsifier in an amount effective to maintain solubility and efficacy of the polymer blend as well as to maintain suspension of any microscopic artifacts is employed. Surfactants exhibit excellent properties of emulsification for simple hydrophobic/hydrophilic mixtures, however, many also provide the ability to combine in an ionic manner with metals and other charged species. Suitable surfactant includes an anionic phosphoric acid ester. The surfactant aids in the manufacturing and filtration of the invention by maintaining low surface tension to keep all contact surfaces wetted for maximum desired processing. The same phenomenon applies during substrate coating, where the topography is wetted and the device areas are penetrated. The surfactant preferably has a high cloud point (i.e. >60° C.) to allow for compatibility during heated processing and good solubility in polymeric materials. The anionic environment is required for corrosion protection of the substrate's sensitive metals and surfaces. Alternative surfactants include polyethylene glycol phenyl ether phosphate under the trade name, Rhodafac™ RP-710, manufactured by Rhodia S. A., Paris, France; and a proprietary phosphate ester under the trade name, Zelec™ UN, manufactured by Stepan Company, Chicago, Ill. Less than about 4% by weight of the anionic surfactant is sufficient.

To afford the ability for easy identification of flaws during fabrication, an inert dye is incorporated into the formulation. Such dyes may be of the visible or fluorescent variety provided they are not sensitive nor do they act as a barrier to ultraviolet light that is required for the function of the radiation cure process. These dyes simply provide an easy positive-identification technique for the material in a manufacturing environment. This type of confirmation and inspection is needed, as it will assist in detecting the presence of artifacts, such as voids or bubbles in the temporary support. This approach is also used to identify unknown residue and help to track its origin, should such material become known during a manufacturing practice.

Dye substances of the visible variety may be chosen from a broad range of industrial materials used for many applications. Such materials are rooted in varieties of pigments. In this invention, the pigments of blue and green are utilized to represent the invention's green character, namely, one that is non-hazardous and reduces the presence of organic solvents during manufacture. Such color tints are produced by the company Crompton& Knowles Corporation, Reading, Pa., and are listed under the trade names, Interplast Brilliant Blue and Oil Soluble Green. Usually less than about 1 weight percent of the inert pigment is sufficient.

In certain compositions of the invention, a UV fluorescent (optical brightener) may be added. The UV fluorescing additive is ideal where it is able to sustain the elevated temperature of 100 degrees centigrade and not interfere with the absorbing wavelengths of the photoinitiator, typically outside of the range 340-380 nm. Common fluorescent dyes, which meet this criteria, include, Rhodamine liquid from Keystone Pacific Division. Usually less than about 1 weight percent of the inert pigment is sufficient.

The UV fluorescent additive is best utilized when inspected just after the post exposure bake (PEB) step following UV cure. In this manner, the material is observed prior to the excessive temperatures of the pre-processing bake and backside operations. The UV additive is detected with the aid of a simple observation microscope having a large focal distance and working area under the objective. With the microscope set-up in a normal observation mode, the specimen is put on the stage and a conventional UV emitting lamp is brought close to allow for excitation of the dye. The lamp may be an industrial variety having a large scattered UV type light bulb at 22 W (watts) or of similar characteristic. With the UV lamp turned on and all white light (conventional light) dimmed or turned off, the operator may observe fluorescence of a specific color of the chosen dye (typically light blue, yellow, orange, or pink) at all locations where the dye is present. Therefore, this technique may be used to detect the adhesive since it is the carrier for the dye. During wafer inspection, the coated surface is observed, and where any dark or black location are indicated, these suggest the lack of adhesive and therefore, the possibility of a void, bubble, or other irregularity. In this case, proper wetting and penetration to microscopic areas in and around the devices on the wafer front side can be verified.

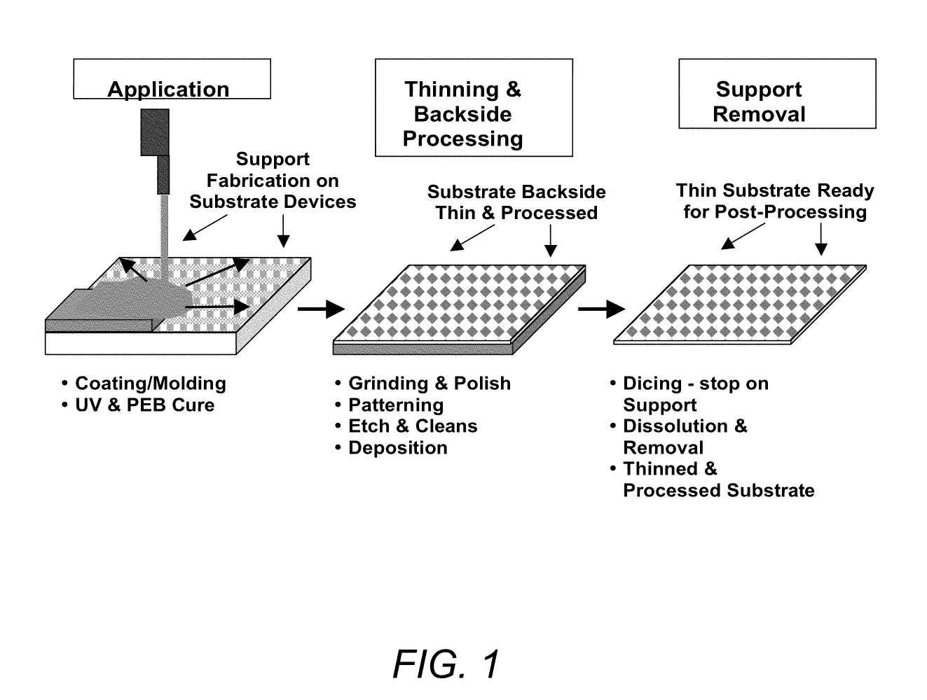

The invention is designed to be applied in many ways, from conventional spin-coating practices as is common to the semiconductor industry, to spray, molding, or slit-coating as is common to the manufacturing of large panels. All of these applications involve pre-mixing the liquid polymer system with photoinitiator to a desired concentration sufficient to achieve the curing reaction. The mixture is applied directly to the front side of the microelectronic substrate (i.e. the device area). Once applied, the curing process proceeds with ultraviolet (UV) light exposure followed by a post exposure bake (PEB) at sufficient temperatures necessary to complete the cure cycle and promote the outgassing of substances which may interfere with subsequent tasks. Once the temporary support is fabricated, the substrate may enter a series of thinning and backside processing steps practiced by the customer. These steps may include grinding, polishing, lithographic patterning, etching, cleans, and deposition. The nature and duration of each of these tasks is dependent upon the customer's product design and tools available in their fab. Upon completion, the completed substrate is observed as thinned and processed on the backside. The customer may decide to conduct substrate dicing before or after support removal. Support removal uses an alkaline chemistry, which interacts with the cured material to dissolve and rinse it away, leaving a thinned and processed substrate. A view of the process defined by the invention is described in FIG. 1.

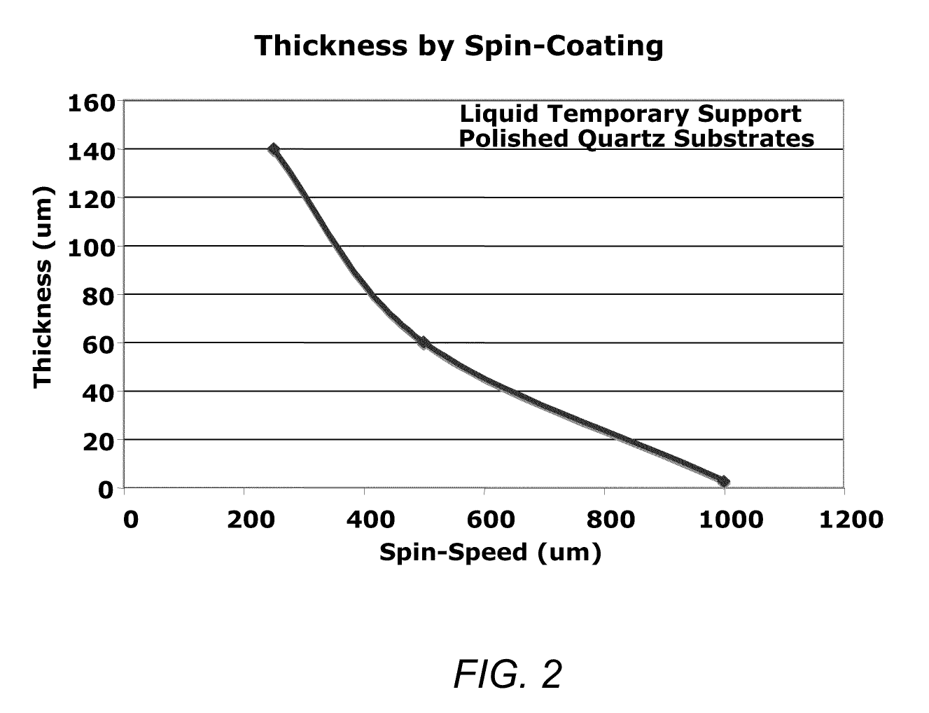

In the case of spin-coating, a silicon wafer is chosen from a variety of diameters. The wafer is staged onto the spin-coating tool, and upon delivery of the liquid support system, the spin tool is initiated. While holding the wafer, a vacuum chuck mechanism begins to spin. As the wafer spins, centrifugal forces are applied to the liquid and forces the material to the outer edge, where upon reaching that point, excess material is propelled and it becomes airborne from the wafer edge and impacts the equipment bowl where it is collected and sent to a waste receptacle. The fluid that remains on the wafer is exposed to ultraviolet light of an energy level at about 160 mili-joules/cm²-sec. The cured coating is quickly transformed from a liquid to a solid. The surface is a smooth over the entire wafer surface with a mirror finish. The variables, which directly affect material thickness, are solution viscosity, volume delivery, and spin speed measured as rotations per minute (rpm). For purposes of achieving spin-coated film, it is desirable to use liquid systems with a solution viscosity of at least 100 centistokes (cSt). When delivering a defined volume to a wafer of a specific diameter and using a spin speed between 250-1000 rpm, the result is a coating thickness that may exceed 50 microns (um), depending upon the system viscosity and presence of fillers. The relationship between thickness and spin speed for coating on smooth substrates is shown in FIG. 2.

Where applicable, the liquid support system is applied in the manner of a coating utilizing a Brewer Science, Inc. CB-100 coater and following standard protocol for applying the liquid material (liquid support system) to the said inorganic substrate. Once the material is coated, it is sent to a UV cure step for <5 min, a soft bake step for a <5 min hot plate bake at 100 degrees C. and follows with a hot plate bake at 200 degrees C. for <5 min. Once cured, the support system is of a rigid state that is sufficient to meet the engineering requirements to sustain substrate thinning and backside processing.

A review of the coating uniformity of the invention indicates that the film formed is smooth and has a total thickness variation (TTV) on a smooth wafer surface of less than 5%, and most preferably, <1% for a precision of between 1-5 um (microns) over the substrate distance for thicknesses between 100-500 um (microns). Low values of TTV suggest a smooth and uniform surface, a necessary characteristic for successful wafer mounting and subsequent operations.

The wafer surface must be smooth and planarized for successful grinding and backside processing. Planarization occurs during the invention application, the liquid temporary support penetrates cavities within the topography and provides a smoothing effect to the surface. Penetration surrounds and protects delicate features such as air bridges and high aspect ratio lines. By surrounding these areas with a hardened substance, any stress that may be applied during thinning will be evenly distributed throughout the substrate. The penetration of the given feature areas by said invention will transform the irregular topography of the front side of the substrate to a surface that is smooth and planarized.

One option of preparing the invention comprises the use of a fabric of a certain composition, weave, and void space between the fibers to allow for impregnation of the resin into that structure and result in maximum wetting and bonding between the fabric and resin and result in improved strength throughout the fabricated structure. It is understood that with respect to the resin system and the fabric, the term “impregnation” means the ability of the resin to penetrate between the individual filaments and achieve maximum immersion.

The fabric, in accordance with this invention, may be a woven variety, whereby the threads are interlaced in a vertical and horizontal manner to achieve a highly organized pattern. The material may also be a nonwoven variety. In a nonwoven, the method of manufacture is not be achieving a specific pattern design, rather, the method is conducted by interlocking the filaments by mechanical entanglement, spun lace, chemical bonding, or thermal melt of a synthetic polymer. Because the nonwoven varieties are more irregular and sometimes involve very “open” interlacing conditions, the fibers are commonly composed of a synthetic variety whereby connections may be achieved by fusing the fibers. Woven fabrics are commonly based upon natural materials such as cellulose.

The fabric may be composed of a wide range of materials to provide structure, form, and support, during fabrication. The composition may include polyester, polyvinylalcohol, nylon, glass, graphite, polyimide, polyamide, polypropylene, and combinations thereof. The fabric should exhibit a density to allow sufficient resin migration and penetration such that complete impregnation is achieved. The fabric material is used to not only produce the invention temporary support, but also is incorporated into the final structure and remains with the support throughout the process, until removal is achieved.

When used during the fabrication process, the cloth-like material is laid down within the boundaries of the desired final support design. The fabric may be inserted at any level of the fabrication process and is dependent upon the design and application sequence as is called-out by the process. For purposes of defining its use and purpose, the example of using it at the beginning of manufacturing is used here.

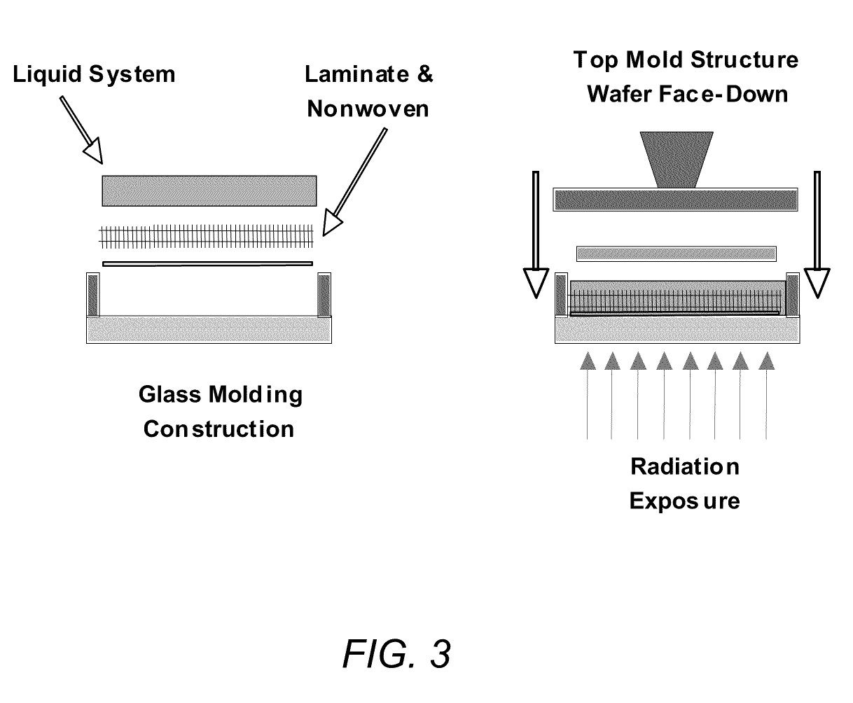

In one embodiment of the invention fabrication, a pre-cut non-woven polyester identified as Colback™ WHD 100, manufactured by Colbond, Inc., is inserted into a glass molding system with a polyolefin laminate (liner) to allow for easy releasing. The mold is designed to accept a 150 mm (6″) diameter silicon wafer and is constructed of glass to allow for maximum transparency to radiation during the cure phase. To this mold, a sufficient amount of the invention liquid system is delivered and allowed to flow and penetrate into the fibers of the nonwoven and fills the cavity of the mold. Onto this mixture, which includes the nonwoven, a silicon wafer of the same size is applied face down. A top structure contacts the wafer and is designed to hold the mold into place with a sufficient pressure to prevent mobility. Upon achieving this state, the ultraviolet lamp, which is oriented to radiate from the bottom-up in the lower portion of the mold, initiates the chemical reaction to cause fixing of the matrix. This exposure is allowed to continue for a period of time sufficient to complete curing of the invention liquid system and convert that to a rigid state (see FIG. 3).

Another approach to fabricating the invention is with the addition of filler substances. These materials are added to enhance strength and hardness. These substances are inert and do not undergo chemical reactions with the resin system. Examples of such materials include amorphous silica, amorphous alumina, glass micro-spheres of a solid or hollow variety, special substances such as boron nitride, titanium dioxide, insoluble cellulose of a micronized nature, and soluble cellulose that includes methyl cellulose, ethyl cellulose, propyl cellulose, and more specifically, hydroxypropyl cellulose.

An additional property of the filler when present in the liquid resin is that the observed solution viscosity will increase. For a given weight, the condition of viscosity is typically inversely proportional to the particle size of the filler additive. Namely, for smaller substances, the observed viscosity will increase at a greater rate. This is due to the high surface area per weight of the substance. Exceptions to this rule include the soluble cellulosic's which become incorporated (e.g. dissolved) into the chemistry of the resin. When soluble cellulosic products are used in the invention, it has been observed that slight or non-detectable differences are observed in the final product. Therefore, soluble cellulosic's will offer options to change the efficacy of the liquid resin without compromise to the final properties of the temporary support.

In one embodiment of this approach, the invention liquid was charged with 2% of amorphous silica identified as Aerosil™ 200, manufactured by Evonik-Degussa, Inc. The solution was mixed with a high-speed mixer (e.g. homogenizer), using a rate of approximately 5,000-20,000 rpm. High speed mixing is conducted for a period of time between 5-30 min, depending upon the mixing set-up and spindle size to vessel ratio.

Preparations with a high speed mixer is common when using amorphous silica as well as other nanoparticulate size species. Mixing under these conditions is observed to be sufficient when proper dispersion of the nanoparticulates has been achieved. Although the measurement and determination of dispersion may be done by monitoring viscosity over a period of time, other practices by those skilled in the art are also observed. One option is to observe the presence of particulate irregularities during coating. Coating irregularities are observed when the species are agglomerated in solution and not properly dispersed. Upon achieving a dispersed condition, the nanoparticulates will be dispersed more uniformly, whereby agglomerates will not be observed.

Once the silica filler dispersion of the invention is determined to be complete, the mixture is removed from the vessel and handled similarly as other candidates. Addition of photoinitiator and the exposure process is similar as compared to the baseline system. The filler system is handled according to the manner of the application objective for the fabrication design. Namely, systems with fillers are used directly in the same sequence as identified in FIG. 1 and may even be used with other special designs such as identified with fabric structures to make composites as identified in FIG. 3.

Inspection of the fabricated temporary support is easily done with an optical microscope of the observation variety, by viewing the wafer through the transparent invention temporary support. Namely, devices may be observed by viewing through the cured support. The transparency of the system is a benefit, which allows device inspection and simple use of front side alignment keys as reference locations to be used during backside operations.

After inspection, the wafer package is sent through a mechanical wafer thinning process. The thinning process is normally conducted at room temperature conditions using a horizontal rotating platter upon which the wafer package is held in intimate contact. There is a liquid media that is used to reduce friction. This media may contain mild chemistries (e.g. fluoride, ammonia, etc.) and/or fine abrasive media. The abrasive media removes gross (large) amounts of the wafer substrate while the mild chemistries are used for microscopic polishing (etching). At the completion of thinning, the package is entered into a stress relieving process, commonly carried out in a strong chemical etchant (i.e. dilute sulfuric, peroxide). The invention is desirable to be resistant to common chemistries used in the stress relief etching process. Once stress relief is completed, the package is rinsed, dried and prepared for backside processing.

As described in FIG. 1, backside processing includes the patterning, etching, and deposition. Patterning is completed through a normal lithography process using photoresist and an aqueous alkaline developer. The invention is resistant to common lithography and development steps used for positive-tone photoresists. Etching is carried out at elevated temperature in a vacuum chamber using a reactive ion etch (RIE) plasma, e.g. BF₃/BCl₃ (boron tri-fluoride/boron tri-chloride). The RIE plasma selectively removes the wafer substrate within a pattern to produce via-holes that are continuous from the backside all the way through to a designated contact metal (etch stop) present on the front side. When cured at the recommended conditions, the invention is compatible up to 250° C. with low outgassing (volatilization). A measurement by thermogravimetric analysis (TGA) methods of the invention at temperatures reaching 250° C. indicates that outgassing at <2% exists for thermal pre-treated specimens of unfilled and filled varieties. Without thermal pre-treatment, specimens are observed to outgas at levels identified as unacceptable for equipment that is sensitive for releases of organic contamination. Low outgassing is required for successful RIE processes.

Once via-hole etching is complete, the resist pattern and etch residue is removed by a cleaning process, whereby the wafer is then metalized with a blanket layer of an inert and highly conductive metal, commonly this will be gold (Au), copper (Cu), nickel (Ni), or similar material. At the chip level, the metal layer provides for rigidity and high conductivity between the backside and the front. This connectivity is required for through-chip contact in design configurations of three-dimensional packaging (3-D packaging) where the stacking of chips is common.

The thinned, backside processed, and metalized wafer is then prepared for demounting (detachment) or cleaning from the temporary support. This process is carried-out by exposure to an alkaline chemistry such as tetramethylammonium hydroxide or similar alkaline reagent that is found in most manufacturing fabs. The alkaline agent has high selectivity towards the invention temporary support with limited or no compromise to the microelectronic substrate or the metallic devices present on the front side. The process is commonly conducted at elevated temperature and may use measures of agitation such as ultrasonic equipment. Once the substrate is cleaned, it is rinsed, dried, and observed to be in a pristine and clean state. The wafer is then ready for dicing into ICs and final packaging to the PWB or other electronic use.

Although the invention has been described in terms of particular embodiments, blends of one or more of the various additives described herein can be used, and substitutes therefore, as will be know to those skilled in the art. Thus the invention is not meant to be limited to the details described herein, but only by the scope of the appended claims.

### EXAMPLES

The invention is further illustrated, without limitation, by the following examples. In the examples #'s 1-9, the composition of the invention and applications are varied to achieve several objectives and to demonstrate versatility. Measurements are made by direct observations and data taken from tools common to most materials laboratories, and where necessary, optical microscopy or special instruments to gain knowledge of the properties of the final product.

Unless otherwise indicated, substrates used are glass of various thicknesses, varying from about 100 um (100 micron=100×10e-6 meters) to 1000 um (1 milimeter). Application equipment includes spin-coater (Model CB100, Brewer Science, Inc., www.brewerscience.com), thickness profilometer (XP-1, Ambios Technology, Inc., www.ambiostech.com), an ultraviolet (UV) light source (Sylvania 365 nm, broad-band, 0.16 W/cm2-sec), and a substrate grinder (N-Tegrity Model 6DSP Grinder/CMP, two spindle, Strasbaugh, www.strasbaugh.com). This equipment forms the basis for the survey to be conducted which the invention will be demonstrated.

The following items in Table 1 represent the specialty substances used to demonstrate the acrylic polymer temporary support structure.

TABLE 1
List of specialty substances used to demonstrate the invention.

| # | Material | Trade Name | Manufacturer |
|---|---|---|---|
| 1 | Rosin, high total | Resinall ™ - (1) | (1) Resinall Corp., www.resinall.com |
| | acid number (TAN | Sylvaprint ™ - | (2) Arizona Chemical Company, |
| | ≧150) | (2) | www.arizonachemical.com |
| 2 | Amorphous Silica | Arosil ™ - (1) | (1) Evonik Degussa Gmbh, |
| | | Cab-o-sil ™-(2) | www.evonik.com |
| | | | (2) Cabot Corporation, www.cabot-corp.com |
| 3 | Soluble Cellulose | Methocel ™ - (1) | (1) Dow Chemical Company, |
| | | Klucel ™ - (1) | www.dow.com |
| | | | (2) Hercules, Inc., www.herc.com |
| 4 | Insoluble Cellulose | Solkafloc ™ | International Fiber Corporation, Inc. |
| | | | (www.solkafloc.com) |
| 5 | Glass Spheres, solid | P-Series, Q - | Potter's Industries, Inc., |
| | and hollow | Cell ™ | www.pottersbeads.com |
| 6 | Boron Nitride | Boron Nitride | Momentive Performance Materials, |
| | Particles | Particles, ≦1um | www.momentive.com |
| | | through ≧100um | |
| 7 | Non-Woven | Colback ™ - (1) | (1) Colbond, Inc., www.colbond.com |
| | | Lutradur ™ - (2) | (2) Freudenberg Nonwovens LP, |
| | | | www.freudenberg.com |
| | | | Ahlstrom Corporation, |
| | | | www.ahlstrom.com |
| | | | Johns Manville Corporation, |
| | | | www.jm.com |
| 8 | Release Film | Polyolefin, | Crystal Vision Packaging Systems, |
| | | LDPE, HDPE, ≦5 mil | www.crystalvisionpkg.com |

### Example 1

### Compositions with Various Photoinitiators to Achieve Rapid Curing

In this experiment, the monomer, n-n-dimethylacrylamide (DMAA) is used as a base resin for the initiator to cause the cure reaction. The resin system is mixed and applied to glass substrates of 1 mm thickness. Exposure conditions with the necessary ultraviolet source is conducted for 5 min and followed with a 100 degree centigrade hot plate exposure. Curing observations are recorded for each stage. The initiators are listed in Table 2 and results are indicated in Table 3.

TABLE 2
Photoinitiator types and concentrations used with acrylic monomer.

| | | Wave- | Concen- |
|---|---|---|---|
| | | length | tration |
| Initiator | Chemistry | (nm) | (%) |
| Irgacure | BAPO/∝-hydroxyketone (Irgacure | 365 | 0.5, 2, 5 |
| 2022 | 819:Darocure 1173, 20:80) | | |
| Irgacure 819 | Phosphine oxide, phenyl bis (2,4,6- | 365 | 0.5, 2, 5 |
| | trimethyl benzoyl) | | |
| Irgacure | 2-Hydroxy-1-[4-(2- | 365 | 0.5, 2, 5 |
| 2959 | hydroxyethoxy)phenyl]-2-methyl-1- | | |
| | propanone | | |
| Darocure | 2-Hydroxy-2-methyl-1-phenyl-1- | 365 | 0.5, 2, 5 |
| 1173 | propanone | | |
| Irgacure 250 | Iodonium, (4-methylphenyl)[4-(2- | 250 | 0.5, 2, 5 |
| | methylpropyl) phenyl]-, | | |
| | hexafluorophosphate(1-) | | |
| Darocure | MAPO/∝-Hydroxyketone (Darocure | 250 | 0.5, 2, 5 |
| 4265 | TPO:1173, 50:50) | | |

TABLE 3
Results of curing with ultraviolet exposure and heating.

| | Concentration | Wavelength | | Heat |
|---|---|---|---|---|
| Initiator | (%) | (nm) | UV Cure | Cure |
| Irgacure 2022 | 0.5 | 365 | Y | — |
| Irgacure 2022 | 2 | 365 | Y | — |
| Irgacure 2022 | 5 | 365 | Y | — |
| Irgacure 819 | 0.5 | 365 | Y | — |
| Irgacure 819 | 2 | 365 | Y | — |
| Irgacure 819 | 5 | 365 | Y | — |
| Irgacure 2959 | 0.5 | 365 | N | N |
| Irgacure 2959 | 2 | 365 | N | N |
| Irgacure 2959 | 5 | 365 | Y | — |
| Darocure 1173 | 0.5 | 365 | Y | — |
| Darocure 1173 | 2 | 365 | Y | — |
| Darocure 1173 | 5 | 365 | Y | — |
| Irgacure 250 | 0.5 | 250 | N | — |
| Irgacure 250 | 2 | 250 | N | N |
| Irgacure 250 | 5 | 250 | N | N |
| Darocure 4265 | 0.5 | 250 | N | N |
| Darocure 4265 | 2 | 250 | N | N |
| Darocure 4265 | 0.5, 2, 5 | 250 | N | N |

Results of this work suggest Irgacure 2022, Irgacure 819, and Darocure 1173 show preferred reaction to form a rigid structure of a thickness>1 mm. From this work, Irgacure 2022 will be used for future experiments.

### Example 2

### Compositions with Various Monomers to Achieve Reduced Internal Stress

In this experiment, various monomers are used as a base resin for the initiator Irgacure 2022 to cause the cure reaction in a manner which results in a relative reduced level of stress. The resin system is mixed and applied to glass substrates of 100 um thickness. Exposure conditions with a 365 nm ultraviolet source is conducted for 5 min and followed with a 100 degree centigrade hot plate exposure. Stress is observed as a bending of the substrate and is recorded for each mixture. The monomers listed in Table 1 are tested for UV curing, heat curing, and stress observations throughout the experiment.

TABLE 4
Monomers and results for UV and thermal cure,
stress measurement to 200 C.

| Iden- | | | |
|---|---|---|---|
| tity | Product Name | Chemistry | Manufacturer |
| A | Ageflex ™ | n,n- | Ciba Specialty Chemicals |
| | NDMAA pure | dimethylacrylamide | Corporation |
| | | (DMAA, CAS | (www.cibasc.com) |
| | | #2680-03-7) | |
| B | Rocryl ™ 400 | hydroxyethyl | Rohm & Haas Company |
| | | methacrylate | (www.rohmhaas.com) |
| | | (CAS #868-77-9) | |
| C | Rocryl ™ 410 | hydroxy propyl | Rohm & Haas Company |
| | | methacrylate (CAS | (www.rohmhaas.com) |
| | | #27813-02-1) | |
| D | Rocryl ™ 420 | hydroxyethyl acrylate | Rohm & Haas Company |
| | | (CAS #818-61-1) | (www.rohmhaas.com) |
| E | Rocryl ™ 430 | hydroxypropyl acrylate | Rohm & Haas Company |
| | | (CAS #25584-83-2) | (www.rohmhaas.com) |

TABLE 5
Results for stress testing on monomer mixtures with
NDMAA, referenced from Table 4 versus the relative
measurement for a baseline structure of pure NDMAA (A)

| Monomer Ratio | Stress Observed |
|---|---|
| B:A, 75:25 | Yes |
| B:A, 50:50 | Yes |
| B:A, 25:75 | Yes |
| C:A, 75:25 | Yes |
| C:A, 50:50 | Yes |
| C:A, 25:75 | Yes |
| D:A, 75:25 | N |
| D:A, 50:50 | N |
| D:A, 25:75 | Yes |
| E:A, 75:25 | N |
| E:A, 50:50 | Yes |
| E:A, 25:75 | Yes |

Results that reduce internal stress in the support material from Example 2 suggest promoting mixtures of monomer D and E, and more preferably, monomer D. In this invention for ease of cure, rapid reaction, and substrate adhesion, monomer D is used in mixtures with monomer A.

### Example 3

### Compositions with High TAN Rosins to Achieve Moisture Resistance & Alkali Solubility

In this experiment, various rosins with high TAN values are added to a base acrylic mixture, cured, and tested against the based product to enhance moisture resistance and alkali solubility. The substances are described as item #1 in Table 1. The substances and results are listed in Table 6.

TABLE 6
Results for cure, moisture resistance, and TMAH dissolution of
rosin additives.

| | | | | TMAH |
|---|---|---|---|---|
| Identity | | | Moisture | Enhanced |
| (TAN) value | Manufacturer | UV Cure | Resistant | Solubility |
| Sylvaprint ™ | Arizona | Yes | Yes | Yes |
| 8200 (199) | | | | |
| Sylvaprint ™ | Arizona | No, requires | Yes | Yes |
| 8250 (246) | | high heat cure | | |
| Resinall ™ | Resinall | No, requires | Yes | No |
| C56-243 | | high heat cure | | |
| (300) | | | | |
| Resinall ™ | Resinall | No, requires | No | No |
| 833 (200) | | high heat cure | | |

Results which enhance moisture resistance and TMAH solubility from Example 3 suggest promoting the additive Sylvaprint™ 8200 in the acrylic mixture. All other TAN additives either did not provide the cure objective, did not provide moisture resistance and TMAH solubility, or both.

### Example 4

### Compositions and Practices to Minimize Material Outgas

In this experiment, various compositions are evaluated for the effect of outgassing as measured by weight loss while undergoing a temperature exposure program. Values are reported as weight stability against the initial weight measured at the experiment start. The solutions stated in Table 7 are prepared with initiator and coated by a spin apparatus. The substrates are quartz glass. Coating conditions include spin-speeds between 500-1000 rpm, and exposure to ultraviolet radiation at a wavelength of 365 nm. Upon curing, the samples are measured gravimetrically. Once they are weighed, the substrates are heated on a hot plate at the identified temperature for 15 min, cooled and the weighing is repeated. This technique closely follows a thermogravimetric analysis (TGA) which represents most thermal analysis equipment. The measurements are normalized for the clean substrate. A series of data measurements are also made for substrates that have been pre-baked to a temperature of 250 degrees centigrade.

TABLE 7
Results for weight consistency on solutions direct and after pre-bake.

| Identity | 100° C. | 150° C. | 200° C. | 250° C. |
|---|---|---|---|---|
| Stock + Cellulose | 95.80% | 85.86% | 80.19% | 75.61% |
| Stock + Silica | 94.92 | 89.93 | 80.30 | 71.61 |
| Stock + Cellulose | 100.00 | 99.72 | 99.35 | 98.60 |
| (after Pre-Baking) | | | | |
| Stock + Silica | 100.00 | 100.54 | 101.09 | 98.37 |
| (after Pre-Baking) | | | | |

Results generated for outgas testing on substrates filled with cellulose or silica suggest weight loss approaching 25% up to 250° C. These numbers are reduced to less than 2% for temperatures up to 250 C after a single pre-bake taken to 250° C.

### Example 5

### Compositions that Include Fillers for Thickness Improvement

In this experiment, various fillers are used at a range of concentrations in the base acrylic liquid system. The fillers are added for purposes of improving our fabrication practices. Namely, by adjusting the rheology of the composition, the system applied may be more viscous and may be more easily applied to molding system. Fillers in this experiment are added to achieve a minimum rheological condition whereby the final condition is stimulated towards a gel state, semisolid condition. The samples are prepared in such a fashion that the added material is very close to forming a gel state (non-pourable). By knowing this information, it is assumed that the material application may be conducted in a manner where product may be inserted into a mold cavity and formed to the shape that is desired. Further and most important, by rheological adjustment, there is an expectation of an increase in the dispersion and suspending properties of the liquid system. Results reported here reflect the capacity to hold solid particles in suspension. The mixture weights, final volume, density and curing is reported in this experiment. Fillers are described in Table 8 and 9, following that reported in Table 1.

TABLE 8
Filler identities and descriptions for mixtures prepared.

| | | | Particle Size | Item # |
|---|---|---|---|---|
| # | Filler Name | Part Number | (um) | (Table 1) |
| 1 | Boron Nitride | NX-1 | 1 | 6 |
| 2 | Boron Nitride | NX-10 | 10 | 6 |
| 3 | Boron Nitride | PT-110 | 100 | 6 |
| 4 | Solkafloc | 300 | 22 | 4 |
| 5 | Aerosil | 200 | <1 | 2 |
| 6 | Solid Spheres | P-0170 | 300-450 | 5 |
| 7 | Solid Spheres | 5000A (GER) | 10 | 5 |
| 8 | Hollow Spheres | 110P98 | 11 | 5 |
| 9 | Hollow Spheres | 25P45 | 40-50 | 5 |
| 10 | Klucel | M-IND | — | 3 |
| 11 | Klucel | M-IND | — | 3 |
| 12 | Klucel | M-IND | — | 3 |
| 13 | Klucel | M-IND | — | 3 |

TABLE 9
Filler properties of final mixtures with invention liquid system.

| | Filler | Weight | | | | |
|---|---|---|---|---|---|---|
| # | weight | Percent | Volume | Density | UV Cure | Appearance |
| 1 | 3 | 23.1 | 10.6 | 1.22 | Y | White, opaque |
| 2 | 5 | 33.3 | 10.6 | 1.41 | Y | White, opaque |
| 3 | 6.6 | 39.8 | 12.0 | 1.38 | Y | White, opaque |
| 4 | 3.2 | 24.1 | 10.2 | 1.30 | Y | Grey, opaque |
| 5 | 0.56 | 5.3 | 9.7 | 1.09 | Y | Transparent |
| 6 | 24.2 | 70.7 | 18.9 | 1.81 | Y | Med. |
| | | | | | | Transparent |
| 7 | 21.4 | 68.1 | 17.1 | 1.84 | Y | White, opaque |
| 8 | 9.5 | 48.8 | 17.5 | 1.11 | Y | White, opaque |
| 9 | 2.9 | 22.2 | 18.0 | 0.71 | Y | White, opaque |
| 10 | 0.3 | 2.9 | 9.7 | 1.06 | Y | Transparent |
| 11 | .2 | 2 | 9.2 | 1.10 | Y | Transparent |
| 12 | .1 | 1 | 9.2 | 1.09 | Y | Transparent |
| 13 | 0.05 | 0.5 | 9.2 | 1.09 | Y | Transparent |

Results of filler testing indicate that substances amorphous silica, certain solid spheres, and soluble cellulose are transparent into the invention liquid system. Solid spheres have the greatest effect on the invention density, achieving density values>1.8 g/ml. Hollow spheres at a specific sizing level, will reduce the density to below that of the starting material (i.e. 1.09 g/ml).

### Example 6

### Fabrication Method by Spin-On Apparatus

In this experiment, compositions of the invention are applied directly to high polished substrates by spin-coating apparatus using a range of rotational speeds, 250, 500, and 1000 rotations per minute (rpm). Curing of the system with photoinitiator, Irgacure 2022, is conducted with UV radiation @ 365 nm, and followed with a PEB at 100° C. for 5 min. Quartz wafers are used as a basis for the material application, measurement of thickness following curing is conducted using a contact micrometer and where necessary, a profilometer; the instruments are described earlier in this section of this document. The data is reported in Table 10.

TABLE 10
Spin-speed thickness data for applied invention to quartz substrates.

| | 250 rpm | 500 rpm | 1000 rpm |
|---|---|---|---|
| Description | (um) | (um) | (um) |
| 0.5% Cellulose | 2.1 | 1.3 | 0.7 |
| 2% Cellulose | 132 | 56 | 2 |

Results of the invention liquid suggest a marked increase in thickness with a coincidence of cellulose addition to drive up viscosity and low rates of rotation.

### Example 7

### Fabrication Method by Molding Apparatus

In this experiment, compositions of the invention are applied directly to a mold design whereby UV radiation is applied from a bottom-up orientation. The mold cavity is constructed with a film of polyolefin in place to act as a release. The mold accepts the invention liquid and fills the design dimensions. Invention systems with filler are applied with compositing fabric as described in item #7 and polyolefin film in item #8 in Table 1. In this fashion, a silicon wafer in a face-down orientation is brought into direct contact with the liquid system. Upon completing the mold, radiation is applied through the glass to trigger polymerization. Thickness results are reported based upon the temporary support applied onto silicon wafers in Table 11.

TABLE 11
Thickness values for temporary support applied to a
silicon wafer using a molding apparatus.

| | | | Total | |
|---|---|---|---|---|
| | Fabric | Filler | Thickness | |
| Item # | Present | Present | (um)* | Uniformity* |
| 3 | No | Yes | 1300 | No |
| 2 | No | Yes | 1350 | No |
| 56-5 | No | Yes | 1350 | No |
| 56-8 | No | Yes | 1400 | No |
| 56-4 | No | Yes | 1100 | No |
| 56-6 | No | Yes | 1350 | No |
| 26-1 | Yes | Yes | 1550 | Yes |
| 26-2 | Yes | Yes | 1550 | Yes |
| 28-1 | Yes | Yes | 1300 | Yes |
| 28-2 | Yes | Yes | 1480 | Yes |

*Total Thickness and Uniformity: measured as wafer + support and <5% variability.

Results from Table 11 suggest the use of fabric for a composite representation of the invention liquid system may improve uniformity.

### Example 8

### Measured Penetration of Liquid Acrylic System to Composite Fabric

In this experiment, the invention liquid system is applied to the composite fabric and allowed to penetrate and be absorbed into its matrix. The system is then cured by normal radiation exposure, heated by 100° C. for 5 min, and followed by observations of the absorption capacity and rigidity measured on a relative basis. The data in Table 12 represents four (4) vendors and composite materials evaluated as identified in item #7 Table 1.

TABLE 12
Absorptivity as weight of liquid into fabric, of invention
liquid system by fabric.

| | | Acrylic + | | |
|---|---|---|---|---|
| Item* | Fabric | Fabric | % Addition | Rigidity |
| F1 | 0.0639 | 0.3911 | 512% | Medium |
| F2 | 0.1061 | 0.4928 | 364% | Low |
| F3 | 0.1164 | 0.5443 | 368% | Low |
| F4 | 0.1642 | 0.8098 | 393% | Low |
| F5 | 0.1827 | 1.1209 | 514% | Medium |
| F6 | 0.2736 | 1.0642 | 289% | Low |
| F7 | 0.1446 | 0.885 | 512% | Medium |
| J1 | 0.2706 | 2.7622 | 921% | High |
| J2 | 0.2533 | 4.8411 | 1811% | High |
| J3 | 0.3081 | 1.9154 | 522% | Medium |
| J4 | 0.2381 | 1.0869 | 356% | Low |
| C1 | 0.1117 | 0.8211 | 635% | High |
| C2 | 0.2255 | 1.2638 | 460% | Medium |
| C3 | 0.0905 | 0.5927 | 555% | Medium |
| C4 | 0.1345 | 0.8057 | 499% | Medium |
| C5 | 0.2344 | 1.3993 | 497% | Medium |
| C6 | 0.1433 | 0.9726 | 579% | Medium |
| C7 | 0.1858 | 1.0775 | 480% | Medium |
| C8 | 0.2698 | 1.425 | 428% | Medium |
| A1 | 0.1001 | 1.2419 | 1141% | High |

Identity of fabrics itemized from the respective manufacturers:
F = Freudenberg,
J = Johns Manville,
C = Colback,
A = Ahlstrom.
See Table 1 for reference.

Rigidity of the composite structure is recognized to be high or medium/high as absorptivity is >500% and most preferred at >600%. Systems which exhibit rigidity at <500% and specifically<400% is considered to be medium/low and low, respectively.

### Example 9

### Measured Substrate Thinning Achieved with Fabricated Invention Temporary Support

In this experiment, silicon wafers are prepared by a molding fabrication apparatus and prepared for grinding to a thin dimension. The invention temporary support matrix chosen for this experiment is based upon a combination of the liquid system, filler of an inert ceramic variety, with a fabric type of that identified from Example 8 with a medium-high or high resin absorption level. The results for grinding a silicon wafer with a fabricated temporary support are given in Table 13.

TABLE 13
Grinding results on silicon wafers with a fabricated temporary support.
Results given are thickness of the thinned wafer in units of microns.

| Wafer # | 1 | 2 | 3 | 4 | 5 | Average | Stdev | % Error |
|---|---|---|---|---|---|---|---|---|
| 1-Origin | 1303 | 1286 | 1304 | 1299 | 1309 | 1300.2 | 8.70 | 0.67% |
| 1-Thinned | 56 | 74 | 55 | 56 | 54 | 59 | 8.43 | 14.28% |
| Si | | | | | | | | |
| 2-Origin | 1366 | 1343 | 1355 | 1335 | 1351 | 1350 | 11.79 | 0.87% |
| 2-Thinned | 73 | 97 | 85 | 104 | 88 | 89.4 | 11.84 | 13.25% |
| Si | | | | | | | | |

Results from Table 13 indicate that wafer grinding achieved thickness levels below 100 um and more preferably, approaching 50 um.

Several embodiments of the present invention have been described. Nevertheless, it will be understood that various modifications may be made without departing from the spirit and scope of the invention. Accordingly, other embodiments are within the scope of the following claims.

What is claimed is:

1. A method for fabricating a rigid temporary support used for supporting inorganic substrates during processing comprising:
providing an inorganic substrate comprising a first surface to be processed and a second surface opposite to said first surface;
applying a liquid layer to said second surface of said inorganic substrate;
curing said applied liquid layer and thereby forming a rigid temporary support attached to said second surface of the inorganic substrate;
processing said first surface of said inorganic substrate while supporting said inorganic substrate upon said rigid temporary support; and
wherein said curing comprises first exposing said applied liquid layer to ultraviolet (UV) radiation and then performing a post exposure bake (PEB) at a temperature sufficient to complete the curing of the applied liquid layer and to promote outgassing of substances.

2. The method of claim 1 wherein the applied liquid layer comprises Component A and Component B, wherein said Component A comprises a primary acrylic monomer or a blend of acrylic monomers having a concentration ranging from about 50.0 to 99.5 weight % and wherein said Component B comprises one or more rosin compounds having a concentration ranging from about 0.5 to 49.5 weight %.

3. The method of claim 2 wherein said applied liquid layer further comprises Component C, wherein said Component C comprises a photoinitiator used to promote curing of the applied liquid layer and has a concentration ranging from about 0.1 weight % to about 20 weight %.

4. The method of claim 2 wherein said acrylic monomers comprise a compound represented by formula (I), 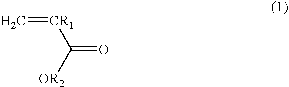
wherein R₁ and R₂ are selected from a group consisting of hydrogen (—H), amide (—NH₂), methyl (—CH₃), hydroxyl (—OH), alcohol (—CH₂₀H), compounds represented by the formula —CₙH₍₂ₙ₊₁₎ or —CₙH₍₂ₙ₎OH wherein n varies from 2-20, aromatic hydrocarbon functional compounds represented by the formula —C₆X₅, wherein X comprises substituent groups selected from a group consisting of hydrogen (—H), the halogens (—F, —Br, —Cl, —I), hydroxyl (—OH), and —COOH, and —COOR₃ groups, wherein R₃ is selected from a group consisting of hydrogen (—H), amide (—NH₂), methyl (—CH₃), hydroxyl (—OH), alcohol (—CH₂₀H) and compounds represented by the formula —CₙH₍₂ₙ₊₁₎ or —CₙH₍₂ₙ₎OH wherein n varies from 2-20.

5. The method of claim 2, wherein said one or more rosin compounds are selected from a group consisting of modified rosins, rosin esters, rosin maleics, rosin-modified phenolics, rosin acids, and hydrocarbon-modified rosin esters.

6. The method of claim 2, wherein said Component B comprises one or more of modified rosin esters having a melting point above 150° C. and a total acid number (TAN) equal or higher than 100 mg/g KOH.

7. The method of claim 3, wherein said Component C comprises one or more compounds selected from a group consisting of phenylglyoxylate, benzyldimethylketal, ∝aminoketone, ∝hydroxyketone, monoacyl phosphine (MAPO), bisacylphosphine (BAPO), metallocene, and iodonium salt.

8. The method of claim 2 wherein said applied liquid layer further comprises one or more fillers at a concentration of about 0.1 weight % to about 85 weight %, and wherein said fillers act as a special aid during fabrication and provide improved engineering properties during processing.

9. The method of claim 8, wherein said fillers are selected from a group consisting of boron nitride, insoluble cellulose, amorphous silica and glass spheres of hollow or solid variety.

10. The method of claim 2 further comprising applying a fabric to said second surface prior to said curing, wherein said fabric comprises an absorptivity value for the liquid layer of above 250 weight % and comprises fibers selected from a group consisting of natural organic substances, cellulose, synthetic organic substances, graphite, polyester, nylon, polyamide, polyimide, polyvinylalcohol, inorganic substances, glass and combinations thereof.

11. The method of claim 1, wherein said curing produces a rigid temporary support comprising a thermal weight loss of <5% as measured by thermal gravimetric analysis (TGA).

12. The method of claim 1, wherein said liquid layer is applied via a spin-coating.

13. The method of claim 1, wherein said liquid layer is applied via molding.

14. The method of claim 1, further comprising removing said rigid temporary support by washing with an aqueous chemistry.

15. A system for fabricating a rigid temporary support used for supporting inorganic substrates during processing comprising:
an inorganic substrate comprising a first surface to be processed and a second surface opposite to said first surface;
means for applying a liquid layer to said second surface of said inorganic substrate;
means for curing said applied liquid layer and thereby forming a rigid temporary support attached to said second surface of the inorganic substrate;
means for processing said first surface of said inorganic substrate while supporting said inorganic substrate upon said rigid temporary support; and
wherein said means for curing comprises means for exposing said applied liquid layer to ultraviolet (UV) radiation and means for performing a post exposure bake (PEB) at a temperature sufficient to complete the curing of the applied liquid layer and to promote outgassing of substances.

16. The system of claim 15 wherein the applied liquid layer comprises Component A and Component B, wherein said Component A comprises a primary acrylic monomer or a blend of acrylic monomers at a concentration ranging from about 50.0 to 99.5 weight % and wherein said Component B comprises one or more rosin compounds having a concentration ranging from about 0.5 to 49.5 weight %.

17. The system of claim 16 wherein said applied liquid layer further comprises Component C, wherein said Component C comprises a photoinitiator used to promote curing of the applied liquid layer and has a concentration ranging from about 0.1 weight % to about 20 weight %.

18. The system of claim 16 wherein said acrylic monomers comprise a compound represented by formula (1), 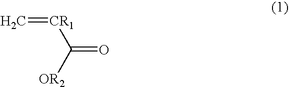
wherein R₁ and R₂ are selected from a group consisting of hydrogen (—H), amide (—NH₂), methyl (—CH₃), hydroxyl (—OH), alcohol (—CH₂₀H), compounds represented by the formula —CₙH₍₂ₙ₊₁₎ or —CₙH₍₂ₙ₎OH wherein n varies from 2-20, aromatic hydrocarbon functional compounds represented by the formula —C₆X₅, wherein X comprises substituent groups selected from a group consisting of hydrogen (—H), the halogens (—F, —Br, —Cl, —I), hydroxyl (—OH), and —COOH, and —COOR₃ groups, wherein R₃ is selected from a group consisting of hydrogen (—H), amide (—NH₂), methyl (—CH₃), hydroxyl (—OH), alcohol (—CH2OH) and compounds represented by the formula —CₙH₍₂ₙ₊₁₎ or —CₙH₍₂ₙ₎OH wherein n varies from 2-20.

19. The system of claim 16, wherein said one or more rosin compounds are selected from a group consisting of modified rosins, rosin esters, rosin maleics, rosin-modified phenolics, rosin acids, and hydrocarbon-modified rosin esters.

20. The system of claim 16, wherein said Component B comprises one or more of modified rosin esters having a melting point above 150° C. and a total acid number (TAN) equal or higher than 100 mg/g KOH.

21. The system of claim 17, wherein said Component C comprises one or more compounds selected from a group consisting of phenylglyoxylate, benzyldimethylketal, ∝caminoketone, ∝hydroxyketone, monoacyl phosphine (MAPO), bisacylphosphine (BAPO), metallocene, and iodonium salt.

22. The system of claim 16 wherein said applied liquid layer further comprises one or more fillers at a concentration of about 0.1 weight % to about 85 weight %, and wherein said fillers act as a special aid during fabrication and provide improved engineering properties during processing.

23. The system of claim 22, wherein said fillers are selected from a group consisting of boron nitride, insoluble cellulose, amorphous silica and glass spheres of hollow or solid variety.

24. The system of claim 16 further comprising means for applying a fabric to said second surface prior to said curing, wherein said fabric comprises an absorptivity value for the liquid layer of above 250 weight % and comprises fibers selected from a group consisting of natural organic substances, cellulose, synthetic organic substances, graphite, polyester, nylon, polyamide, polyimide, polyvinylalcohol, inorganic substances, glass and combinations thereof.

25. The system of claim 15, wherein said means for curing produces a rigid temporary support comprising a thermal weight loss of <5% as measured by thermal gravimetric analysis (TGA).

26. The system of claim 15 wherein said means for applying said liquid layer comprise a spin-coating apparatus.

27. The method of claim 15 wherein said means for applying said liquid layer comprise a molding apparatus.

28. The method of claim 15, further comprising means for removing said rigid temporary support by washing with an aqueous chemistry.
